(19) United States
(12) Patent Application Publication
(10) Pub. No.: US 2024/0272955 A1
(43) Pub. Date: Aug. 15, 2024

(54) RESOURCE MANAGEMENT FOR MULTI-PRODUCT AND MULTI-HOMED SYSTEMS

(71) Applicant: Rubrik, Inc., Palo Alto, CA (US)

(72) Inventors: David Anthony Terei, New York, NY (US); Johanna Braun, Seattle, WA (US); Hoang Nguyen Bao Nguyen, San Jose, CA (US); Jun Xu, Seattle, WA (US)

(21) Appl. No.: 18/169,606

(22) Filed: Feb. 15, 2023

(51) Int. Cl. G06F 9/50; G06F 16/23; G06F 16/25

(52) U.S. Cl. CPC G06F 9/5055; G06F 16/23; G06F 16/252

(57) ABSTRACT

Methods, systems, and devices for data management are described. A database for managing one or more subscriptions to a cloud service that provides computing resources may be generated. The database may include multiple tables corresponding to multiple geographic regions. Based on the subscriptions, the tables may be updated to reflect respective computing resource allotments for respective geographic regions. A request to apply a software-as-a-service product to customer data may be received from a geographic region. In response to the request, available computing resources for the geographic region may be identified and a determine of whether to configure the available computing resources for the instantiation of the software-as-a-service product instance may be determined. Based on the determining, an indication of whether the software-as-a-service product instance is initiated may be provided.

### FIELD OF TECHNOLOGY

The present disclosure relates generally to data management, including techniques for resource management for multi-product and multi-homed systems.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports resource management for multi-product and multi-homed systems in accordance with aspects of the present disclosure.

FIG. 2 illustrates an example of a subsystem that supports resource management for multi-product and multi-homed systems in accordance with aspects of the present disclosure.

FIG. 3 illustrates an example of a database that supports resource management for multi-product and multi-homed systems in accordance with aspects of the present disclosure.

FIG. 4 illustrates an example of a set of operations that supports resource management for multi-product and multi-homed systems in accordance with aspects of the present disclosure.

FIG. 5 illustrates an example of a data structure that supports resource management for multi-product and multi-homed systems in accordance with aspects of the present disclosure.

FIG. 6 illustrates a block diagram of an apparatus that supports resource management for multi-product and multi-homed systems in accordance with aspects of the present disclosure.

FIG. 7 illustrates a block diagram of a data manager that supports resource management for multi-product and multi-homed systems in accordance with aspects of the present disclosure.

FIG. 8 illustrates a diagram of a system including a device that supports resource management for multi-product and multi-homed systems in accordance with aspects of the present disclosure.

FIG. 9 illustrates a flowchart showing methods that support resource management for multi-product and multi-homed systems in accordance with aspects of the present disclosure.

### DETAILED DESCRIPTION

A data management system (DMS) may use internal software products to process data stored by the DMS (e.g., software for searching for anomalies, threats, and/or malware, software for identifying certain content in data, software for backing up particular application data, etc.). In some examples, the DMS may provide customers the ability to process data that is not stored by the DMS using one or more of the internal software products. That is, the DMS may offer customers access to internal software products in a standalone format (which may be referred to as software-as-a-service (SaaS) format). In some examples, the DMS may use cloud-based computing resources (e.g., managed by a third-party cloud service, such as Microsoft Azure) to support the operation of SaaS product instances (e.g., instances of a SaaS product initiated for different customers). To access the cloud-based computing resources, the DMS may procure one or more subscriptions to the cloud-based computing resources—e.g., for a particular quantity of processing unit resources, for a particular quantity of clusters, etc.

In some examples, customers that are spread across multiple geographic regions in a geographic area (e.g., North America) may request access to multiple SaaS products offered by the DMS. In such cases, if the DMS initiates clusters for the customers in accordance with a general subscription for a large quantity of computing resources, one or more of the corresponding SaaS product instances may operate with reduced performance or fail. That is, under the general subscription model, the DMS may not have control over where computing resources are geographically located and incongruities between the geographic distribution of computing resources that are available and allocated to the DMS under the subscription and the geographic distribution of the customers may cause performance issues. For example, if a majority of the customers are concentrated in a particular geographic region (e.g., Northeast US), a performance of a SaaS product instance may be reduced (or an instantiation of the SaaS product instance denied and computing resources wasted) if the allocated computing resources are located in another geographic region (e.g., the Pacific Northwest).

Moreover, the cloud service may not inform the DMS 110 as to geographic locations of the computing resources allocated under the subscription, as to which computing resources are allocated to which SaaS product instances, etc. Thus, a complexity associated with managing (e.g., monitoring, procuring, allocating, etc.) available computing resources for existing and new SaaS product instances may increase based on this lack of information. Thus, techniques and configurations for determining available computing resource allocations on a geographic region level and for determining real-time usage of computing resources on a geographic region level may be desired.

To determine available computing resource allocations on a geographic region level, techniques for identifying and monitoring a geographic location of computing resources allocated under one or more subscriptions may be established. Also, to manage real-time usage of computing resources, techniques for determining the real-time usage of the computing resources and calculating computing resource limits on a geographic level may be established.

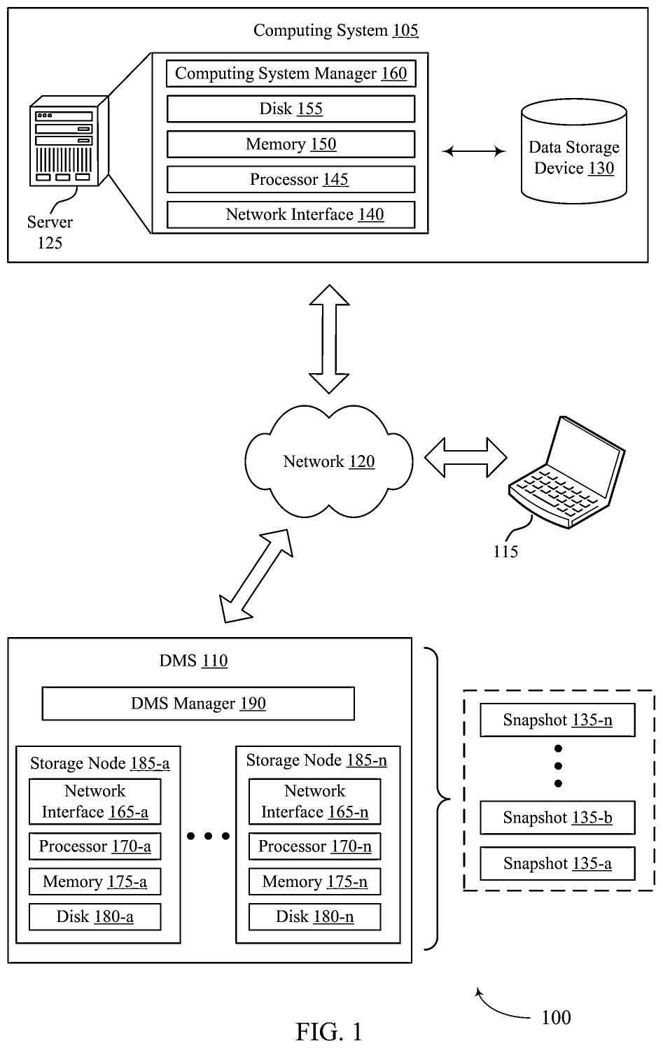

FIG. 1 illustrates an example of a computing environment 100 that supports resource management for multi-product and multi-homed systems in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random-access memory (SRAM), dynamic random-access memory (DRAM), read-only memory ((ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state-which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

As described herein, the DMS 110 may execute software for processing (e.g., backing up, analyzing, etc.) data stored at the computing system 105, the DMS 110, or both. For example, the DMS 110 may execute threat monitoring software, threat hunting software, anomaly detection software, malware detection software, data governance software (e.g., software for identifying certain types of data, such as structured data, personal identifiable information, etc.), system backup software, application backup software (e.g., software for backing up data generated by proprietary applications, such as Microsoft 365), and the like. In such cases, the DMS 110 may provide both the software for processing the data and the infrastructure (e.g., the computing and storage resources) for supporting the operation of the software. In some examples, agents of the DMS 110 are installed at a computing system to facilitate the data processing operations.

In some examples, the DMS 110 includes multiple data management clusters, where each data management cluster may separately process (e.g., backup, analyze) data stored for the computing system 105. The different data management clusters provide redundant protection or provide failover functionality. In some examples, the DMS 110 runs a control layer software that orchestrates the data management operations that are performed across multiple data management clusters, where the data management clusters may be separated from one another (e.g., logically, or physically)—e.g., instead of running separate control software at each of the data management clusters.

In some examples, rather than providing its data processing software only to customers that use the underlying infrastructure of the DMS 110, the DMS 110 may offer a customer access to its data processing software in a standalone format—e.g., under a software-as-a-service (SaaS) model that offers customers access to one or more SaaS products. In such cases, a customer may purchase access to one or more SaaS products (e.g., a threat monitoring SaaS product, a data governance software SaaS product, etc.) supported by the DMS 110—e.g., without using the data storage or management functionality of the DMS 110. In some examples, the control layer software at the DMS 110 may be used to manage the provisioning of the SaaS products to customers.

In some examples, in response to a request from a customer to access a SaaS product and in order to initiate and execute an instance of the SaaS product for the customer, the DMS 110 (e.g., the control layer software) may request (virtual) computing resources from a third-party provider (e.g., a cloud service, such as Microsoft Azure) that are configurable to support the operation of the SaaS product instance. The computing resources may include processing units, volatile memory resources, non-volatile memory resources, network interfaces, and the like. Based on obtaining the computing resources, the DMS 110 (e.g., the control layer software) may instantiate a cluster for supporting the operation of the SaaS product instance. A cluster may include one or more nodes (which may be implemented as virtual machines), where the computing resources may be distributed among the one or more nodes. For example, a certain quantity of processing unit resources, memory resources, etc. may be allocated to individual nodes. The instantiated nodes may be used to support the operation of the instance of the SaaS product—e.g., the nodes may perform the storage and data processing operations of the SaaS product. In some examples, a portion of the computing resources may be maintained in an unused state and subsequently allocated to additional nodes—e.g., to accommodate increases in the processing load of the SaaS product instance. The process of creating additional nodes to support increased processing load may be referred to as scaling or auto-scaling (e.g., if performed autonomously by the third-party provider).

In some examples, the DMS 110 (e.g., the control layer software) may obtain access to computing resources in advance—e.g., through a subscription to a cloud service. The terms of the subscription may designate an amount of computing and storage resources that are available to the DMS 110 (e.g., the control layer software) under the subscription. In some examples, the subscription indicates a quantity of computing resources (e.g., a quantity of central processing units, an amount of volatile memory, an amount of non-volatile memory, a quantity of network interfaces, etc.) that are available to the DMS 110 (e.g., via the control layer software), a quantity of clusters (e.g., Azure Kubernetes Clusters) that can be initiated, or both. In some examples, the subscription may provide the DMS 110 (e.g., the control layer software) access to two-thousand (2000) virtual computing resources and may enable the generation of up to thirty (30) clusters of nodes, where the nodes may be allocated computing resources from the pool of available computing resources. For example, the nodes may be allocated one or more central processing units, varying amounts of memory, and the like.

When a subscription is used, the DMS 110 (e.g., the control layer software) may, in response to a request from a customer to access a SaaS product, initiate a cluster in order to initiate and execute an instance of the SaaS product for the customer. Based on the cluster being initiated, a quantity of clusters available to the DMS 110 under the subscription may be reduced accordingly. Also, as part of initiating the cluster, the DMS 110 (e.g., the control layer software) may instantiate one or more nodes of the cluster, where each node may be designated computing resources (e.g., each node may be designated two central processing units). Based on the cluster of nodes being initiated, the cloud service may allocate computing resources to the initiated nodes. Based on instantiating the nodes, an amount of computing resources (e.g., central processing unit resources) available to the DMS 110 under the subscription may be reduced accordingly. In some examples, on average, a cluster used to support a SaaS product instance for a customer includes 30 nodes and 60 central processing unit resources (e.g., as two central processing unit resources may be allocated to each node).

In some examples, customers that are spread across multiple geographic regions in a geographic area (e.g., North America) may request access to multiple SaaS products offered by the DMS 110. In such cases, if the DMS 110 initiates clusters for the customers in accordance with a general subscription for a large quantity of computing resources, one or more of the corresponding SaaS product instances may operate with reduced performance or fail. That is, under the general subscription model, the DMS 110 may not have control over where computing resources are geographically located and incongruities between the geographic distribution of computing resources that are available and allocated to the DMS 110 under the subscription and the geographic distribution of the customers may cause performance issues. For example, if a majority of the customers are concentrated in a particular geographic region (e.g., Northeast US), a performance of a SaaS product instance may be reduced (or an instantiation of the SaaS product instance denied and computing resources wasted) if the allocated computing resources are located in another geographic region (e.g., the Pacific Northwest).

Moreover, the cloud service may not inform the DMS 110 as to geographic locations of the computing resources allocated under the subscription, as to which computing resources are allocated to which SaaS product instances, etc. Thus, a complexity associated with managing (e.g., monitoring, procuring, allocating, etc.) available computing resources for existing and new SaaS product instances may increase based on this lack of information. For example, the DMS 110 may be unable to determine how which and how many of the computing resources are allocated to which SaaS products, how many computing resources are available for a SaaS product in a geographic region, etc. Thus, techniques and configurations for determining available computing resource allocations on a geographic region level and SaaS product level as well as techniques and configurations for determining real-time usage of computing resources on a geographic region level and SaaS product level may be desired.

To determine available computing resource allocations on a geographic region level and/or SaaS product level, techniques for identifying and monitoring a geographic allocation for computing resources allocated under one or more subscriptions to one or more SaaS products may be established. Also, to manage real-time usage of computing resources, techniques for determining the real-time usage of the computing resources and calculating computing resource limits on a geographic level and/or SaaS product level may be established.

In some examples, the DMS 110 may support the operation of one or more SaaS products, which may correspond to software elements applicable to data stored within the DMS 110. The DMS 110 may generate a database for managing one or more subscriptions to a cloud service that provides the data management system access to computing resources that are managed by the cloud service and are configurable by the DMS 110 to support a remote operation of one or more instances of the one or more SaaS products. Based on generating the database, the DMS 110 may generate multiple tables for the database, where the tables may correspond to multiple geographic regions in a geographic area (e.g., North America). In some examples, each table may correspond to a unique subscription/geographic region combination—e.g., one table may correspond to a first subscription and a first geographic region. The DMS 110 may update the tables based on the one or more subscriptions such that the tables may reflect respective computing resource allotments for respective geographic regions as allocated by the one or more subscriptions. For example, a first table may indicate a computing resource allotment for a first geographic region under a first subscription, another table may indicate a second computing resource allotment for a second particular geographic region under the first subscription, a third table may indicate a third computing resource allotment for the first, second, or a third geographic region under the first subscription or a second subscription, and so on.

The DMS 110 may receive a request from a customer to apply a SaaS product to the data of the customer—e.g., to data stored in the computing system 105. The request may originate from a geographic region. In response to the request, the DMS 110 may identify available computing resources for the geographic region—e.g., based on determining a computing resource allotment for the geographic region and a usage of the computing resource allotment. In some examples, the available computing resources for the geographic region may be identified for one or more subscriptions that are associated with (e.g., that were obtained explicitly for) the SaaS product. Based on the identified available computing resources, the DMS 110 may determine whether to configure at least a portion of the available computing resources for instantiation of an instance of the SaaS product to run for the customer. Based on the determination, the DMS 110 may provide an indication of whether the SaaS product instance was successful.

By monitoring computing resource allocations/usage at a geographic region level, management (e.g., procurement, provisioning, monitoring, etc.) of available computing resources for different SaaS product instances may be simplified—e.g., when servicing SaaS requests originating from multiple geographic regions using a single subscription. Additionally, or alternatively, by monitoring computing resource allocations/usage at a SaaS product level, management of available computing resources for different SaaS product instances may be simplified—e.g., when servicing SaaS requests for different SaaS products using a single subscription. Moreover, by monitoring computing resource allocations/usage at a geographic region level and/or SaaS product level, computing resource limits for SaaS products, geographic regions, or both, may be dynamically calculated.

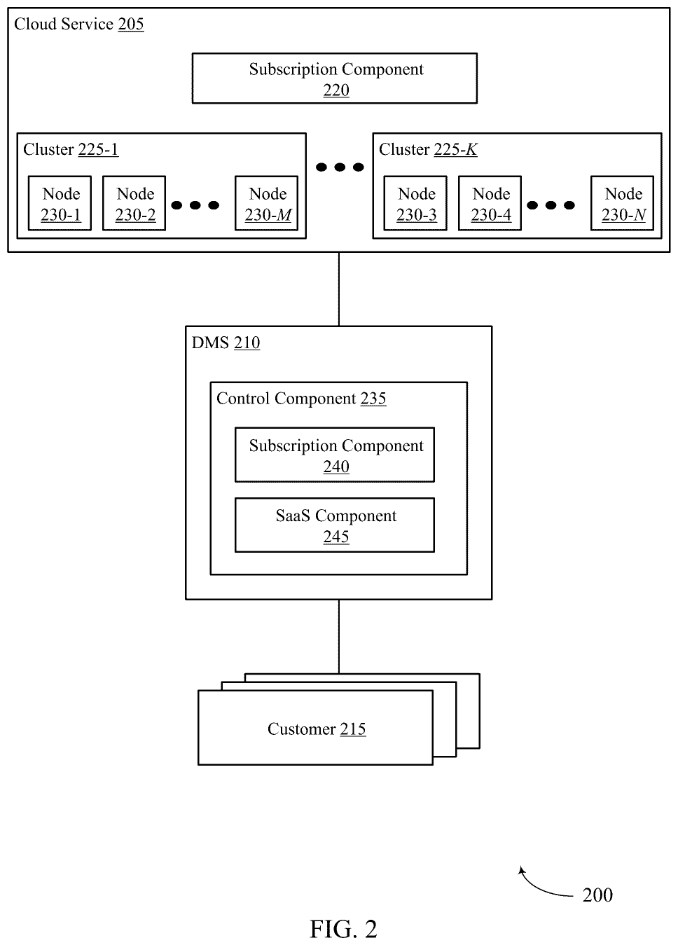

FIG. 2 illustrates an example of a subsystem that supports resource management for multi-product and multi-homed systems in accordance with aspects of the present disclosure.

The subsystem 200 depicts the cloud service 205, the DMS 210, and the one or more customers 215. The DMS 210 may be an example of a DMS described herein (e.g., the DMS 110 of FIG. 1).

The cloud service 205 may provide cloud-based computing resources, such as cloud-based processing resources, cloud-based storage resources, cloud-based networking resources, and the like. In some examples, the cloud service 205 includes a collection of data centers that are distributed across one or more geographic areas. In some examples, individual data centers are used to provide the computing resources for and support the generation of corresponding clusters. For example, a first data center may be located in the Pacific Northwest and be used to generate the first cluster 225-1, and another data center may be located in the Northeast US and used to generate the Kth cluster 225-K.

The cloud service 205 may offer access to the computing resources by way of subscriptions that give a subscriber access to a threshold amount of the computing resources—e.g., for a fixed period of time. In some examples, the subscription component 220 of the cloud service 205 is used to manage and assist in administering existing subscriptions. For example, the subscription component 220 may store a subscription associated with the DMS 210.

In response to a request from a customer (e.g., a request received from the DMS 210) to access computing resources under the subscription, the cloud service 205 may be configured to instantiate one or more clusters (e.g., the first cluster 225-1 through the Kth cluster 225-K). The one or more clusters 225 may each include one or more nodes that are configurable to support the operation of a SaaS product (e.g., a SaaS product instance) offered by an operator of the DMS 210. The cloud service 205 may allocate computing resources to the nodes—e.g., the cloud service 205 may allocate two central processing units, x GBs of volatile memory, y GBs of non-volatile memory, a network interface, etc. to each node. In some examples, the nodes are implemented as virtual machines.

The cloud service 205 may be configured to increase the quantity of clusters and nodes allocated to the DMS 210—e.g., in response to additional requests to instantiate additional clusters, as a customer's usage of a SaaS product offered by the DMS 210 increase, as more customers use the one or more SaaS products offered by the DMS 210, etc. In some examples, the cloud service 205 may determine (e.g., in coordination with the subscription component 220) that all of the computing resources available to the DMS 110 under the subscription have been allocated and may refrain from provisioning additional computing resources to the DMS 110.

The DMS 210 may be configured to offer SaaS products to customers and to provision computing resources for operating instances of the SaaS products. In some examples, each instance of a SaaS product corresponds to a request for the SaaS product. In some examples, the control component 235 of the DMS 210 is configured to offer the SaaS products and to provision the computing resources—e.g., within a particular geographic area, such as North America. In some examples, the DMS 210 may include multiple control components that each serve different geographic areas.

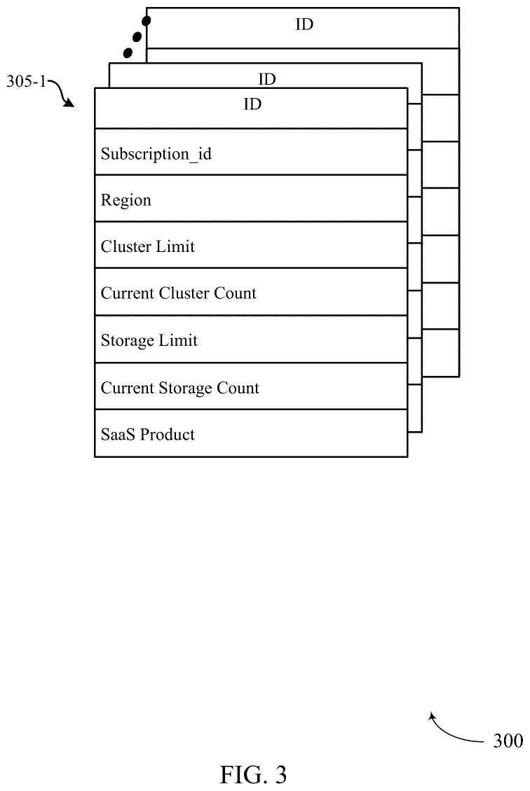

The control component 235 may be configured to procure and manage one or more subscriptions to the cloud service 205 (e.g., via the subscription component 240). In some examples, the subscription component 240 procures subscriptions on a per SaaS product basis. In some examples, each subscription grants the control component 235 access to a maximum amount of computing resources offered by the cloud service 205 under a single subscription. In some examples, the subscription component 240 is configured to determine a geographic distribution of the computing resources that are available to the control component 235 under the one or more subscriptions. For example, the subscription component 240 may determine a geographic distribution of the computing resources at a geographic region level. In some examples, the subscription component 240 is configured to manage a database (e.g., the database 300 of FIG. 3) that keeps track of available computing resources at the geographic region level—e.g., as subscriptions are added, modified, or removed.

The control component 235 may be further configured to instantiate (e.g., via the SaaS component 245) an instance of a SaaS product in response to a request for the SaaS product received from a customer (e.g., the customer 215). As part of instantiating the SaaS product instance, the SaaS component 245 may instantiate a cluster (e.g., the first cluster 225-1) at the cloud service 205. In some examples, based on instantiating the cluster, the cloud service 205 may allocate a predetermined quantity of nodes to the cluster. The cloud service 205 may be further configured to automatically increase/decrease the quantity of nodes allocated to the cluster—e.g., based on a real-time processing load of the cluster. In some examples, the cluster of nodes are instantiated in accordance with an image provided by the SaaS component, where the image comprises the code for supporting the operation of a corresponding SaaS product. In some examples, after the cluster of nodes has been instantiated, the SaaS component 245 may configure the nodes to support the operation of a corresponding SaaS product—e.g., by creating one or more containers that support the operation of the SaaS product.

In some examples, prior to instantiating a cluster of nodes, the SaaS component 245 may determine a geographic region from which the request is received. Based on determining the geographic region, the SaaS component 245 may attempt to instantiate a cluster within that geographic region. In some examples, the SaaS component 245 may deny the request based on determining that there are no available clusters within the geographic region. Additionally, or alternatively, the SaaS component may determine whether there are available clusters within a nearby geographic region. In some examples, the SaaS component 245 may deny the request based on determining that there are no available computing resources within the geographic region—e.g., even if there are available clusters in the geographic region. This may happen if a majority of the customers and/or the largest customers are located within another geographic region and have secured a threshold quantity (e.g., all) of the available computing resources.

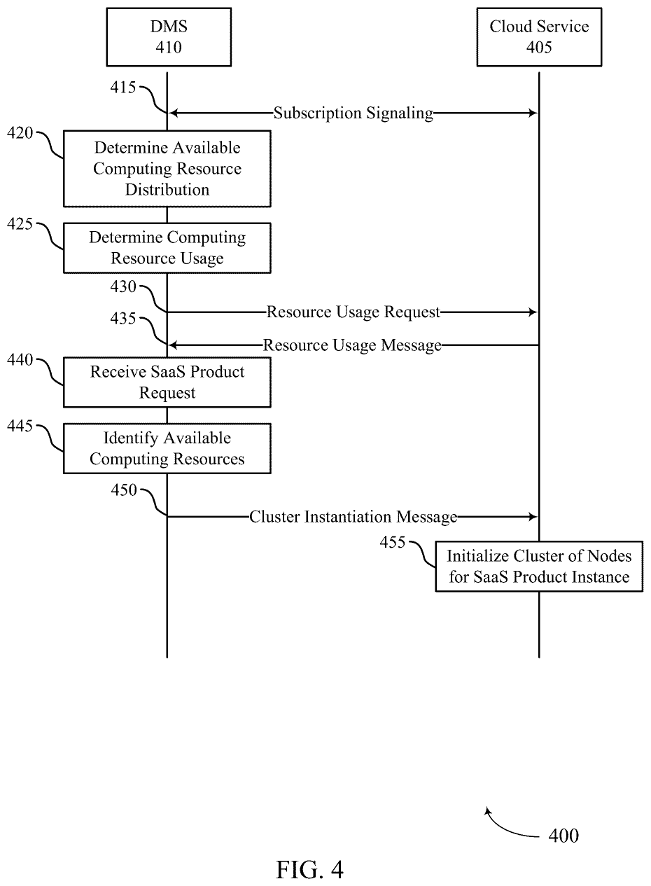

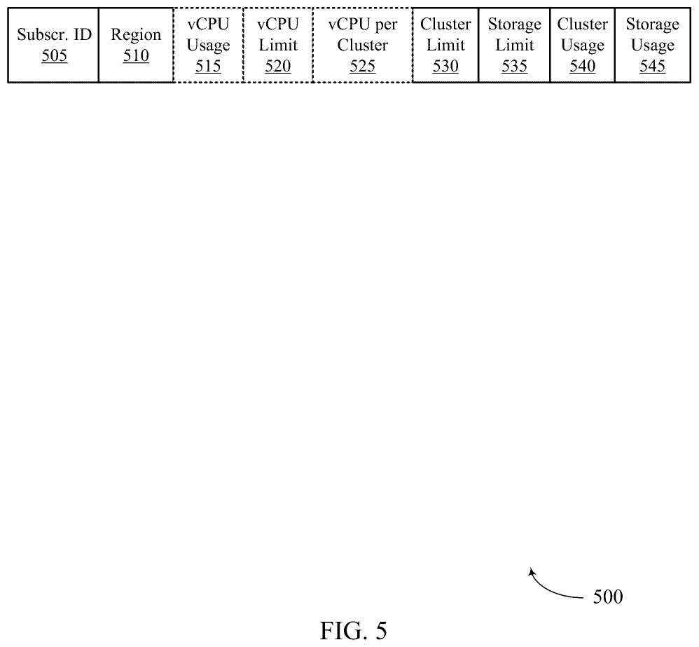

The subscription component 240 may be configured to monitor the computing resources being used by the control component 235 on a real-time basis and on a per-region level—e.g., as described herein, including with reference to FIGS. 4 and 5. In some examples, the subscription component 240 may be configured to obtain the real-time usage of computing resources in different regions based on requesting, from the cloud service 205, the current allocation of computing resources within a region. The subscription component 240 may use the information to determine resource usage within a geographic region, forecast a load within a geographic region, etc. In some examples, the subscription component 240 may be configured to overwrite an internal computation of the real-time usage of computing resources with the indication of the real-time usage of computing resources received from the cloud service 205. The subscription component 240 may be further configured to monitor the computing resources being used by the control component 235 on a per-SaaS product basis, and may use the information to determine resource usage of a SaaS product, forecast a load for a SaaS product, etc.

The customer 215 may be an operator of a computing system (e.g., the computing system 105 of FIG. 1). In some examples, the customers may be distributed across a geographic area. In some cases, a majority of the customers and/or the largest customers may be located within one or more geographic regions of the geographic area—e.g., a majority of the customers may be located within the Pacific Northwest and the Northeast US.

FIG. 3 illustrates an example of a database that supports resource management for multi-product and multi-homed systems in accordance with aspects of the present disclosure.

The database 300 is configured to monitor a distribution of cloud-based computing resources that are available to support the operation of one or more SaaS services offered by a provider under one or more subscriptions of the provider to a cloud service. The database 300 may include multiple tables (including the first table 305-1) that are used to monitor an amount of computing resources that are available within a set of geographic regions under one or more subscriptions. For example, the first table 305-1 may be used to monitor an amount of computing resources that are available within a geographic region under a subscription.

In some examples, each table may include a unique identifier that is associated with a unique combination of a subscription and a region. Also, a table may include a subscription_id field that identifies the subscription under which the available computing resources are available. A region field that identifies a region in which a portion of the available computing resources is available. A cluster limit field that indicates a maximum quantity of clusters that can be generated within the region. A current cluster count field that indicates a quantity of clusters that are currently activated within the region. A storage limit field that indicates a maximum amount of storage that is available within the region. A current storage count field that indicates an amount of storage that is current being used within the region. And a SaaS product field that indicates a SaaS product (e.g., a M365 Backup product, a threat hunting product, etc.) for which the subscription was obtained.

In some examples, the database 300 may be updated (e.g., by the subscription component 240 of FIG. 2)—e.g., periodically; as subscriptions are added, deleted, or modified; etc.

FIG. 4 illustrates an example of a set of operations that supports resource management for multi-product and multi-homed systems in accordance with aspects of the present disclosure.

The process flow 400 may be performed by the DMS 410 and the cloud service 405, which may be respective examples of a DMS (e.g., the DMS 110 of FIG. 1, the DMS 210 of FIG. 2) and a cloud service (e.g., the cloud service 205) described herein. In some examples, the process flow 400 shows an example set of operations performed to support resource management for multi-product and multi-homed systems. For example, the process flow 400 may include operations for managing computing resources that are available under one or more subscriptions on a per-region level and/or per-SaaS product level.

At 415, signaling for obtaining a subscription may be exchanged between the DMS 410 (e.g., a subscription component of the DMS 410, which may be an example of the subscription component 240 of FIG. 2) and the cloud service 405. In some examples, the subscription component requests a separate subscription for each SaaS product offered by the DMS 410. In some examples, each subscription requested by the subscription component requests a full amount of computing resources (e.g., 2000 processing units), clusters (30 clusters), or both, that are available under a subscription.

In some examples, as part of the subscription signaling, the subscription component requests an indication of a geographic distribution of the computing resources and/or clusters that are available under each subscription requested by the subscription component. In response to the request, the cloud service 405 may provide an indication of a geographic distribution of the computing resources available to the DMS 410 under the one or more subscriptions—e.g., at a geographic region level.

At 420, a distribution of the computing resources may be determined (e.g., by the subscription component). In some examples, the subscription component may determine, for each subscription, a quantity of computing resources and/or clusters that are available in each geographic region of a set of geographic regions. The subscription component may further generate a set of tables to indicate the geographic distribution of the computing resources and/or clusters—e.g., as described herein, including with reference to FIG. 3. In some examples, the subscription component may generate a table for each subscription/region pair that indicates an identifier of the subscription, an identifier of the region, a quantity of available clusters, an amount of available storage, a current cluster usage, a current storage usage, a SaaS product for which the subscription/region pair relates, or any combination thereof.

In some examples, the subscription component may use the tables to determine an amount of available computing resources within a geographic region—e.g., by adding up the available computing resources in a geographic region across the one or more subscriptions. Additionally, or alternatively, the subscription component may use the tables to determine an amount of available computing resources for a SaaS product—e.g., by adding up the available computing resources for one or more subscriptions procured for the SaaS product. The subscription component may further use the table to determine an amount of available computing resources within a geographic region for each SaaS product offered by the DMS 410—e.g., by adding up the available computing resources in a geographic region across one or more subscriptions procured for the SaaS product.

In some examples, the control component may use the determined computing resource distribution to dynamically calculate available clusters in a geographic region—e.g., based on the data structure of FIG. 5. For example, the control component may determine a quantity of clusters that may be activated within a geographic region under a subscription based on a quantity of available vCPU resources within the geographic region and an average amount of vCPU resources that are allocated to a cluster within the geographic region. For instance, the control component may determine that 1500 vCPU resources are available within the geographic region and that, on average, 60 vCPU resources are used per cluster. Accordingly, the control component may determine that 25 (1500/60) clusters may be activated within the geographic region.

Additionally, or alternatively, the control component may similarly use the determined computing resource distribution to dynamically calculate available clusters in a geographic region for a particular SaaS product, where the average quantity of vCPU resources used per cluster may change from SaaS product to SaaS product. For instance, the control component may determine that 1000 vCPU resources are available for the SaaS product within the geographic region and that, on average, 30 vCPU resources are used per cluster. Accordingly, the control component may determine that 33 (1000/30) clusters may be activated within the geographic region for the SaaS product. That said, the control component may determine that fewer clusters are available if the determined quantity of clusters exceeds a subscription limit (e.g., of 30 clusters).

At 425, a usage of the computing resources available under the one or more subscriptions may be determined (e.g., by a control component of the DMS 410, such as the control component 235 of FIG. 2). In some examples, the control component determines a usage of the computing resources based on the requests for SaaS products received from and serviced for customers seeking access to the SaaS products. For example, the control component may keep track of a quantity of clusters that have been instantiated for the requested SaaS products and may compute a usage based on the quantity of clusters and average vCPU usage per cluster. Also, the control component may determine a usage of the computing resources on a geographic region level based on geographic origins of the requests.

In some examples, the control component monitors (e.g., on a per-region basis, on a per SaaS product basis, etc.) an amount of free computing resources based on comparing the determined available computing resources with the estimated usage of the available computing resources. If the amount of free computing resources (for a SaaS product, for a geographic region, for a SaaS product within a geographic region, etc.) falls below a threshold, the control component may issue a warning to an operator of the DMS 410.

In some examples, the control component may use the determined computing resource distribution and the determined resource usage to dynamically calculate available clusters in a geographic region—e.g., based on the data structure of FIG. 5. For example, the subscription component may determine a quantity of clusters that may be activated within a region under a subscription based on a quantity of vCPU resources being used within the region, a quantity of available vCPU resources within the region, an average amount of vCPU resources that are allocated to a cluster within the region; and a quantity of clusters currently being used within the region. For instance, the subscription component may determine 1000 vCPU resources are being used within the region, that 1500 vCPU resources are available within the region and that, on average, 60 vCPU resources are used per cluster. Accordingly, the subscription component may determine that

$$16 ( 8 + \frac{1500 - 1000}{60} )$$

clusters may be activated within the region, in accordance with the following calculation:

$${cl}_{used} + \frac{{vCPU}_{quota} - {vCPU}_{used}}{{vCPU}_{percl}} .$$

At 430, a resource usage request may be sent (e.g., by the control component) to the cloud service 405. The resource usage request may request a real-time subscription-level and geographic-level accounting of the current computing resource and/or cluster usage of the computing resources that are currently allocated to the DMS 410 under the one or more subscriptions.

At 435, a resource usage message may be received (e.g., by the control component) in response to the resource usage request. The resource usage message may provide a real-time subscription-level and geographic-level accounting to the DMS of the computing resources and/or clusters currently allocated to the DMS 410. In some examples, the resource usage indicated by the cloud service may differ from the estimated resource usage calculated by the control component. In some examples, the control component may overwrite the estimated resource usage with the resource usage indicated by the cloud service. In such cases, the cloud service may be used as the “source-of-truth” for computing resource usage.

At 440, a SaaS product request may be received (e.g., by a SaaS component of the DMS 410, such as the SaaS component 245 of FIG. 2). The SaaS product request may identify a request for a SaaS product of a set of SaaS products offered by the DMS 410. The SaaS product request may also indicate a geographic location from which the request initiation, a requested geographic location for deployment of the SaaS product, or both. The SaaS product request may also indicate a size or anticipated size of a dataset for which the SaaS product is requested.

At 445, available computing resources may be identified (e.g., by the control component) in response to the SaaS product request. In some examples, the control component determines an amount of computing resources that are free for the SaaS product within a geographic region—e.g., the geographic region from which the SaaS product request originated, the geographic region requested in the SaaS product request. In some examples, the control component may determine that the amount of free computing resource is sufficient to support the operation of an instance of the SaaS product.

At 450, a message for instantiating a cluster for running the instance of the SaaS product may be sent (e.g., by the control component) to the cloud service 405—e.g., based on determining that the amount of free computing resource is sufficient. In some examples, the message may indicate a geographic region for the cloud service 405 to instantiate the cluster within. In some examples, the cluster instantiation message includes an image for initializing nodes in the cluster—e.g., an image associated with operating the SaaS product instance.

At 455, a set of nodes may be initialized (e.g., by the cloud service 405) for the cluster, where the nodes may be configured to support the operation of the SaaS product instance. In some examples, the nodes are configured to support the operation of the SaaS product instance at the time of initialization—e.g., if the nodes are configured in accordance with an image for the SaaS product. Additionally, or alternatively, the nodes may be configured to support the operation of the SaaS product instance after initialization—e.g., the control component may configure one or more containers at the nodes that support the operation of the SaaS product instance. Once the SaaS product instance has been instantiated, a customer may interact with the cluster of nodes to access the functionality of the SaaS product.

By managing the computing resources obtained under one or more subscriptions on a per-region level and/or per-SaaS product level, the DMS 410 may be capable of determining computing resource availability on a per-region level and/or per-SaaS product level. Additionally, by tracking real-time usage of the computing resources on a per-region level and/or per-SaaS product level, the DMS 410 may be capable of dynamically calculating cluster limits on a per-region level and/or per-SaaS product level. Thus, the DMS 410 may be able to understand a computing resource need at a region and SaaS product level and, therefore, may quickly adapt to changing computing resource needs on a region and SaaS product level. That is, the DMS 410 requests fewer or additional computing resources for a SaaS product based on monitored availability/usage. The DMS 410 may be able to request fewer or additional computing resources for a geographic area based on monitored availability/usage. And the DMS 410 may be able to request fewer or additional computing resources for a SaaS product within a geographic region based on monitored availability/usage.

Aspects of the process flow 400 may be implemented by a controller, among other components. Additionally, or alternatively, aspects of the process flow 400 may be implemented as instructions stored in memory (e.g., firmware stored in a memory coupled with a controller). For example, the instructions, when executed by a controller, may cause the controller to perform the operations of the process flow 400.

One or more of the operations described in the process flow 400 may be performed earlier or later, omitted, replaced, supplemented, or combined with another operation. Also, additional operations described herein may replace, supplement or be combined with one or more of the operations described in the process flow 400.

FIG. 5 illustrates an example of a data structure that supports resource management for multi-product and multi-homed systems in accordance with aspects of the present disclosure.

The data structure 500 may be configured to enable static and dynamic calculation of computing resources and/or cluster limitations for a subscription within a region. The data structure 500 may include the subscription identifier field 505, the region field 510, the vCPU usage field 515, the vCPU limit field 520, the cluster-level vCPU field 525, the cluster limit field 530, the storage limit field 535, the cluster usage field 540, and the storage usage field 545.

The subscription identifier field 505 may identify the subscription for which the computing resource/cluster limitations are to be calculated. The region field 510 may identify the region for which the computing resource/cluster limitations are to be calculated. The vCPU usage field 515 may indicate a quantity of virtual central processing units currently in use within the region under the subscription. The vCPU limit field 520 may indicate a quantity of virtual central processing units that are available within the region under the subscription. The cluster-level vCPU field 525 may indicate an average quantity of virtual central processing units that is expected to be used by a cluster. The cluster limit field 530 may indicate a quantity of clusters that are available within the region under the subscription. The storage limit field 535 may indicate an amount of storage that is available within the region under the subscription. The cluster usage field 540 may indicate a quantity of clusters currently in use within the region under the subscription. The storage usage field 545 may indicate an amount of storage currently in use within the region under the subscription.

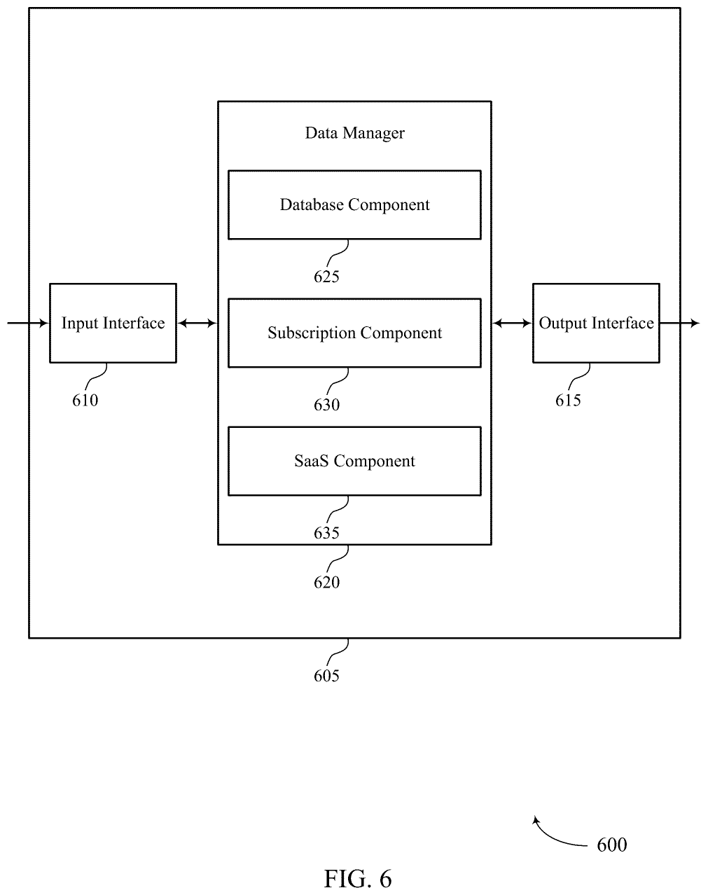

FIG. 6 illustrates a block diagram 600 of a system 605 that supports resource management for multi-product and multi-homed systems in accordance with aspects of the present disclosure. In some examples, the system 605 may be an example of aspects of one or more components described with reference to FIG. 1, such as a DMS 110. The system 605 may include an input interface 610, an output interface 615, and a data manager 620. The system 605 may also include one or more processors. Each of these components may be in communication with one another (e.g., via one or more buses, communications links, communications interfaces, or any combination thereof).

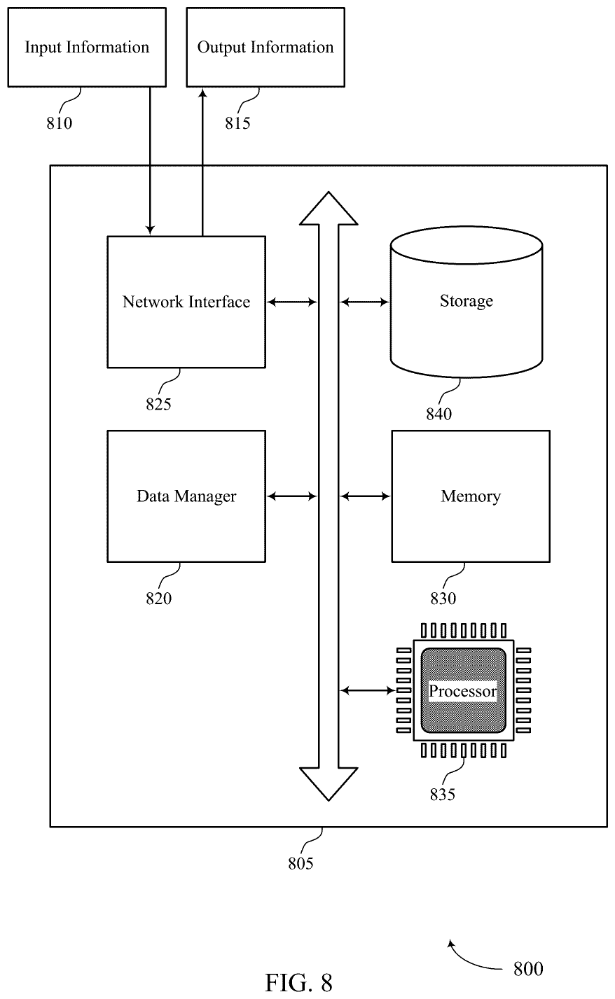

The input interface 610 may manage input signaling for the system 605. For example, the input interface 610 may receive input signaling (e.g., messages, packets, data, instructions, commands, or any other form of encoded information) from other systems or devices. The input interface 610 may send signaling corresponding to (e.g., representative of or otherwise based on) such input signaling to other components of the system 605 for processing. For example, the input interface 610 may transmit such corresponding signaling to the data manager 620 to support resource management for multi-product and multi-homed systems. In some cases, the input interface 610 may be a component of a network interface 825 as described with reference to FIG. 8.

The output interface 615 may manage output signaling for the system 605. For example, the output interface 615 may receive signaling from other components of the system 605, such as the data manager 620, and may transmit such output signaling corresponding to (e.g., representative of or otherwise based on) such signaling to other systems or devices. In some cases, the output interface 615 may be a component of a network interface 825 as described with reference to FIG. 8.

For example, the data manager 620 may include a database component 625, a subscription component 630, a SaaS component 635, or any combination thereof. In some examples, the data manager 620, or various components thereof, may be configured to perform various operations (e.g., receiving, monitoring, transmitting) using or otherwise in cooperation with the input interface 610, the output interface 615, or both. For example, the data manager 620 may receive information from the input interface 610, send information to the output interface 615, or be integrated in combination with the input interface 610, the output interface 615, or both to receive information, transmit information, or perform various other operations as described herein.

The database component 625 may be configured as or otherwise support a means for generating, by a data management system that supports one or more software-as-a-service products, a database for managing one or more subscriptions to a cloud service that provides the data management system access to computing resources managed by the cloud service. The database component 625 may be configured as or otherwise support a means for generating, by the data management system, based on generating the database, a set of multiple tables for the database, the set of multiple tables corresponding to a set of multiple geographic regions in a geographic area. The subscription component 630 may be configured as or otherwise support a means for updating, by the data management system, the set of multiple tables based on the one or more subscriptions, where the set of multiple tables is updated to reflect respective computing resource allotments for respective geographic regions as allocated to the data management system by the one or more subscriptions. The SaaS component 635 may be configured as or otherwise support a means for receiving, by the data management system and via a user interface, a request to apply a software-as-a-service product of the one or more software-as-a-service products to data of a customer, where the request originates from a geographic region. The subscription component 630 may be configured as or otherwise support a means for identifying, by the data management system, in response to the request and based on a computing resource allotment for the geographic region, available computing resources for the geographic region. The SaaS component 635 may be configured as or otherwise support a means for determining, by the data management system, based on the available computing resources, whether to configure at least a portion of the available computing resources for instantiation of an instance of the software-as-a-service product. The SaaS component 635 may be configured as or otherwise support a means for providing, by the data management system via the user interface, an indication of whether the instance of the software-as-a-service product is instantiated.

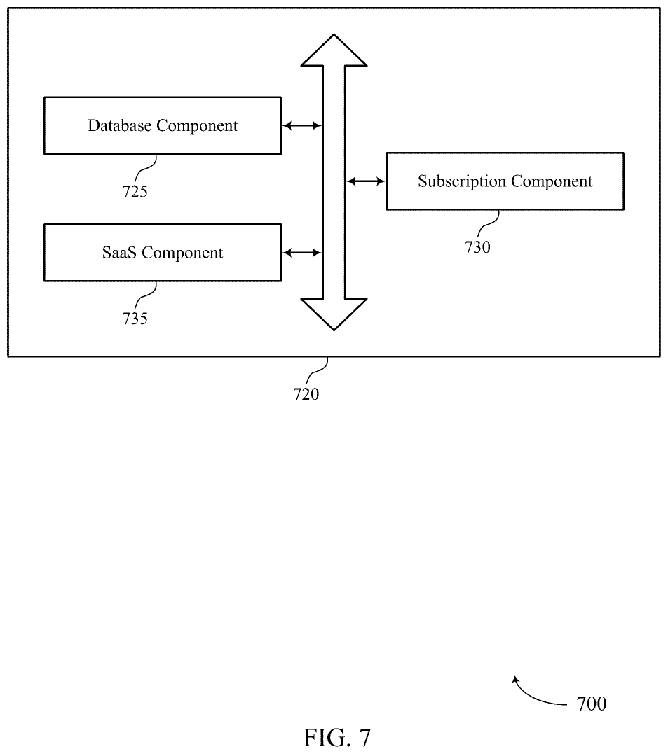

FIG. 7 illustrates a block diagram 700 of a data manager 720 that supports resource management for multi-product and multi-homed systems in accordance with aspects of the present disclosure. The data manager 720 may be an example of aspects of a data manager or a data manager 620, or both, as described herein. The data manager 720, or various components thereof, may be an example of means for performing various aspects of resource management for multi-product and multi-homed systems as described herein. For example, the data manager 720 may include a database component 725, a subscription component 730, a SaaS component 735, or any combination thereof. Each of these components may communicate, directly or indirectly, with one another (e.g., via one or more buses, communications links, communications interfaces, or any combination thereof).

The database component 725 may be configured as or otherwise support a means for generating, by a data management system that supports one or more software-as-a-service products, a database for managing one or more subscriptions to a cloud service that provides the data management system access to computing resources managed by the cloud service. In some examples, the database component 725 may be configured as or otherwise support a means for generating, by the data management system, based on generating the database, a set of multiple tables for the database, the set of multiple tables corresponding to a set of multiple geographic regions in a geographic area. The subscription component 730 may be configured as or otherwise support a means for updating, by the data management system, the set of multiple tables based on the one or more subscriptions, where the set of multiple tables is updated to reflect respective computing resource allotments for respective geographic regions as allocated to the data management system by the one or more subscriptions. The SaaS component 735 may be configured as or otherwise support a means for receiving, by the data management system and via a user interface, a request to apply a software-as-a-service product of the one or more software-as-a-service products to data of a customer, where the request originates from a geographic region. In some examples, the subscription component 730 may be configured as or otherwise support a means for identifying, by the data management system, in response to the request and based on a computing resource allotment for the geographic region, available computing resources for the geographic region. In some examples, the SaaS component 735 may be configured as or otherwise support a means for determining, by the data management system, based on the available computing resources, whether to configure at least a portion of the available computing resources for instantiation of an instance of the software-as-a-service product. In some examples, the SaaS component 735 may be configured as or otherwise support a means for providing, by the data management system via the user interface, an indication of whether the instance of the software-as-a-service product is instantiated.

In some examples, the subscription component 730 may be configured as or otherwise support a means for requesting, from the cloud service, an indication of the respective computing resource allotments for the respective geographic regions. In some examples, the subscription component 730 may be configured as or otherwise support a means for receiving, in response to the requesting, the indication of the respective computing resource allotments for the respective geographic regions, where the set of multiple tables is updated based on the indication of the respective computing resource allotments for the respective geographic regions.

In some examples, the subscription component 730 may be configured as or otherwise support a means for determining, based on the indication of the respective computing resource allotments, a quantity of available processing unit resources for the geographic region. In some examples, the subscription component 730 may be configured as or otherwise support a means for calculating a threshold quantity of clusters that is available to support operation of the software-as-a-service product within the geographic region based on. In some examples, the subscription component 730 may be configured as or otherwise support a means for dividing the quantity of the available processing unit resources for the geographic region by an average quantity of processing unit resources allocated to a cluster.

In some examples, the subscription component 730 may be configured as or otherwise support a means for requesting, from the cloud service, an indication of a current usage of the respective computing resource allotments for the respective geographic regions. In some examples, the subscription component 730 may be configured as or otherwise support a means for receiving, in response to the requesting, the indication of the current usage of the respective computing resource allotments for the respective geographic regions, where the set of multiple tables is updated based on the indication of the current usage of the respective computing resource allotments for the respective geographic regions.

In some examples, the subscription component 730 may be configured as or otherwise support a means for requesting, from the cloud service, an indication of the respective computing resource allotments for the respective geographic regions and an indication of a current usage of available processing unit resources for the respective geographic regions. In some examples, the subscription component 730 may be configured as or otherwise support a means for determining, based on the indication of the respective computing resource allotments, a quantity of available processing unit resources for the geographic region, a current usage of the available processing unit resources for the geographic region, and a current usage of clusters for the geographic region. In some examples, the subscription component 730 may be configured as or otherwise support a means for calculating a threshold quantity of clusters that is available to support operation of the software-as-a-service product within the geographic region based on. In some examples, the subscription component 730 may be configured as or otherwise support a means for dividing a difference between the quantity of the available processing unit resources and the current usage of the available processing unit resources by an average quantity of processing unit resources allocated to a cluster. In some examples, the subscription component 730 may be configured as or otherwise support a means for combining a result of the dividing with the current usage of clusters for the geographic region.

In some examples, to support identifying the available computing resources for the geographic region, the subscription component 730 may be configured as or otherwise support a means for determining the computing resource allotment for the geographic region and a current usage of the computing resource allotment based on reading a table of the set of multiple tables that is associated with the geographic region. In some examples, to support identifying the available computing resources for the geographic region, the subscription component 730 may be configured as or otherwise support a means for determining a difference between the computing resource allotment and the current usage of the computing resource allotment, where the available computing resources corresponds to the difference.

In some examples, the SaaS component 735 may be configured as or otherwise support a means for determining, based on identifying the available computing resources for the geographic region, that the available computing resources for the geographic region includes computing capacity that exceeds a threshold, where determining whether to configure at least the portion of the available computing resources includes determining to configure at least the portion of the available computing resources based on the computing capacity of the available computing resources exceeding the threshold.

In some examples, the subscription component 730 may be configured as or otherwise support a means for monitoring, using the set of multiple tables, respective computing capacities of available computing resources within the respective geographic regions. In some examples, the subscription component 730 may be configured as or otherwise support a means for issuing, based on monitoring the respective computing capacities, an alert that a computing capacity of available computing resources for a second geographic region is below a threshold.

In some examples, the subscription component 730 may be configured as or otherwise support a means for requesting, from the cloud service, based on the computing capacity of the available computing resources for the second geographic region being below the threshold, additional computing resources for the second geographic region.

In some examples, a first table of the set of multiple tables includes a first unique identifier of the first table, a first identifier of a first subscription associated with the first table, a first identifier of a first geographic region associated with the first table, a first indication of a first computing resource allotment for the first geographic region under the first subscription, a first indication of a current usage of the first computing resource allotment for the first geographic region under the first subscription, a first indication of a first software-as-a-service product of the one or more software-as-a-service products that is associated with the first subscription, or any combination thereof.

In some examples, a table of the set of multiple tables corresponds to a unique combination of the one or more subscriptions and the set of multiple geographic regions.

In some examples, the computing resources managed by the cloud service are configurable to support a remote operation of one or more instances of the one or more software-as-a-service products.

FIG. 8 illustrates a block diagram 800 of a system 805 that supports resource management for multi-product and multi-homed systems in accordance with aspects of the present disclosure. The system 805 may be an example of or include the components of a system 605 as described herein. The system 805 may include components for data management, including components such as a data manager 820, an input information 810, an output information 815, a network interface 825, a memory 830, a processor 835, and a storage 840. These components may be in electronic communication or otherwise coupled with each other (e.g., operatively, communicatively, functionally, electronically, electrically; via one or more buses, communications links, communications interfaces, or any combination thereof). Additionally, the components of the system 805 may include corresponding physical components or may be implemented as corresponding virtual components (e.g., components of one or more virtual machines). In some examples, the system 805 may be an example of aspects of one or more components described with reference to FIG. 1, such as a DMS 110.

The network interface 825 may enable the system 805 to exchange information (e.g., input information 810, output information 815, or both) with other systems or devices (not shown). For example, the network interface 825 may enable the system 805 to connect to a network (e.g., a network 120 as described herein). The network interface 825 may include one or more wireless network interfaces, one or more wired network interfaces, or any combination thereof. In some examples, the network interface 825 may be an example of may be an example of aspects of one or more components described with reference to FIG. 1, such as one or more network interfaces 165.

Memory 830 may include RAM, ROM, or both. The memory 830 may store computer-readable, computer-executable software including instructions that, when executed, cause the processor 835 to perform various functions described herein. In some cases, the memory 830 may contain, among other things, a basic input/output system (BIOS), which may control basic hardware or software operation such as the interaction with peripheral components or devices. In some cases, the memory 830 may be an example of aspects of one or more components described with reference to FIG. 1, such as one or more memories 175.

The processor 835 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 835 may be configured to execute computer-readable instructions stored in a memory 830 to perform various functions (e.g., functions or tasks supporting resource management for multi-product and multi-homed systems). Though a single processor 835 is depicted in the example of FIG. 8, it is to be understood that the system 805 may include any quantity of one or more of processors 835 and that a group of processors 835 may collectively perform one or more functions ascribed herein to a processor, such as the processor 835. In some cases, the processor 835 may be an example of aspects of one or more components described with reference to FIG. 1, such as one or more processors 170.

Storage 840 may be configured to store data that is generated, processed, stored, or otherwise used by the system 805. In some cases, the storage 840 may include one or more HDDs, one or more SDDs, or both. In some examples, the storage 840 may be an example of a single database, a distributed database, multiple distributed databases, a data store, a data lake, or an emergency backup database. In some examples, the storage 840 may be an example of one or more components described with reference to FIG. 1, such as one or more network disks 180.

For example, the data manager 820 may be configured as or otherwise support a means for generating, by a data management system that supports one or more software-as-a-service products, a database for managing one or more subscriptions to a cloud service that provides the data management system access to computing resources managed by the cloud service. The data manager 820 may be configured as or otherwise support a means for generating, by the data management system, based on generating the database, a set of multiple tables for the database, the set of multiple tables corresponding to a set of multiple geographic regions in a geographic area. The data manager 820 may be configured as or otherwise support a means for updating, by the data management system, the set of multiple tables based on the one or more subscriptions, where the set of multiple tables is updated to reflect respective computing resource allotments for respective geographic regions as allocated to the data management system by the one or more subscriptions. The data manager 820 may be configured as or otherwise support a means for receiving, by the data management system and via a user interface, a request to apply a software-as-a-service product of the one or more software-as-a-service products to data of a customer, where the request originates from a geographic region. The data manager 820 may be configured as or otherwise support a means for identifying, by the data management system, in response to the request and based on a computing resource allotment for the geographic region, available computing resources for the geographic region. The data manager 820 may be configured as or otherwise support a means for determining, by the data management system, based on the available computing resources, whether to configure at least a portion of the available computing resources for instantiation of an instance of the software-as-a-service product. The data manager 820 may be configured as or otherwise support a means for providing, by the data management system via the user interface, an indication of whether the instance of the software-as-a-service product being instantiated.

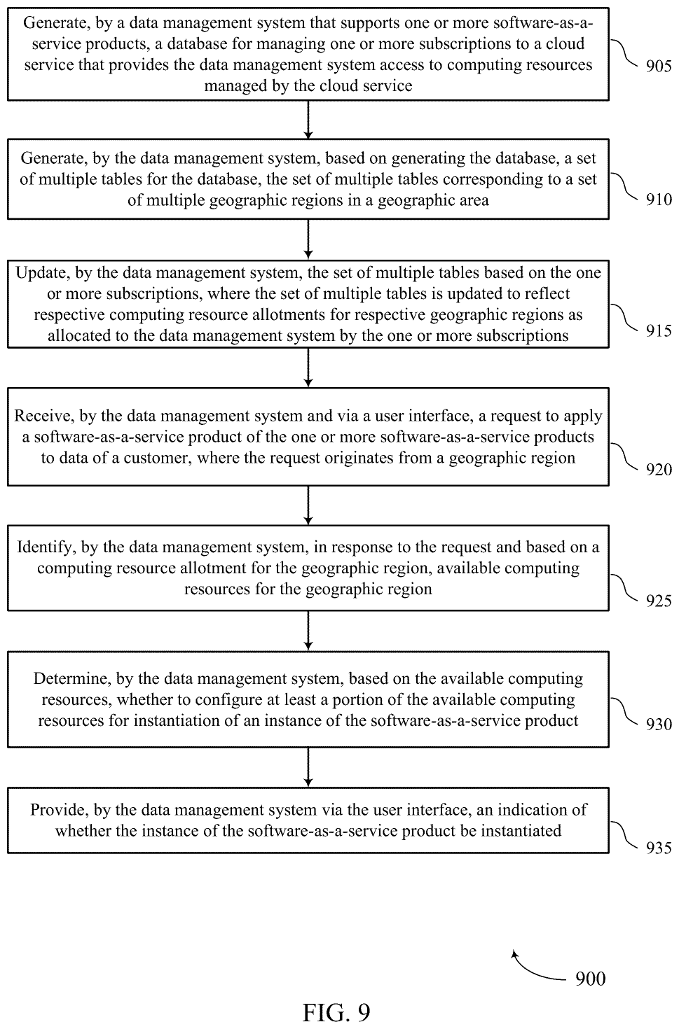

FIG. 9 illustrates a flowchart showing a method 900 that supports resource management for multi-product and multi-homed systems in accordance with aspects of the present disclosure. The operations of the method 900 may be implemented by a DMS or its components as described herein. For example, the operations of the method 900 may be performed by a DMS as described with reference to FIGS. 1 through 8. In some examples, a DMS may execute a set of instructions to control the functional elements of the DMS to perform the described functions. Additionally, or alternatively, the DMS may perform aspects of the described functions using special-purpose hardware.

At 905, the method may include generating, by a data management system that supports one or more software-as-a-service products, a database for managing one or more subscriptions to a cloud service that provides the data management system access to computing resources managed by the cloud service. The operations of 905 may be performed in accordance with examples as disclosed herein. In some examples, aspects of the operations of 905 may be performed by a database component 725 as described with reference to FIG. 7.

At 910, the method may include generating, by the data management system, based on generating the database, a set of multiple tables for the database, the set of multiple tables corresponding to a set of multiple geographic regions in a geographic area. The operations of 910 may be performed in accordance with examples as disclosed herein. In some examples, aspects of the operations of 910 may be performed by a database component 725 as described with reference to FIG. 7.

At 915, the method may include updating, by the data management system, the set of multiple tables based on the one or more subscriptions, where the set of multiple tables is updated to reflect respective computing resource allotments for respective geographic regions as allocated to the data management system by the one or more subscriptions. The operations of 915 may be performed in accordance with examples as disclosed herein. In some examples, aspects of the operations of 915 may be performed by a subscription component 730 as described with reference to FIG. 7.

At 920, the method may include receiving, by the data management system and via a user interface, a request to apply a software-as-a-service product of the one or more software-as-a-service products to data of a customer, where the request originates from a geographic region. The operations of 920 may be performed in accordance with examples as disclosed herein. In some examples, aspects of the operations of 920 may be performed by a SaaS component 735 as described with reference to FIG. 7.

At 925, the method may include identifying, by the data management system, in response to the request and based on a computing resource allotment for the geographic region, available computing resources for the geographic region. The operations of 925 may be performed in accordance with examples as disclosed herein. In some examples, aspects of the operations of 925 may be performed by a subscription component 730 as described with reference to FIG. 7.

At 930, the method may include determining, by the data management system, based on the available computing resources, whether to configure at least a portion of the available computing resources for instantiation of an instance of the software-as-a-service product. The operations of 930 may be performed in accordance with examples as disclosed herein. In some examples, aspects of the operations of 930 may be performed by a SaaS component 735 as described with reference to FIG. 7.

At 935, the method may include providing, by the data management system via the user interface, an indication of whether the instance of the software-as-a-service product is instantiated. The operations of 935 may be performed in accordance with examples as disclosed herein. In some examples, aspects of the operations of 935 may be performed by a SaaS component 735 as described with reference to FIG. 7.

A method is described. The method may include generating, by a data management system that supports one or more software-as-a-service products, a database for managing one or more subscriptions to a cloud service that provides the data management system access to computing resources managed by the cloud service, generating, by the data management system, based on generating the database, a set of multiple tables for the database, the set of multiple tables corresponding to a set of multiple geographic regions in a geographic area, updating, by the data management system, the set of multiple tables based on the one or more subscriptions, where the set of multiple tables is updated to reflect respective computing resource allotments for respective geographic regions as allocated to the data management system by the one or more subscriptions, receiving, by the data management system and via a user interface, a request to apply a software-as-a-service product of the one or more software-as-a-service products to data of a customer, where the request originates from a geographic region, identifying, by the data management system, in response to the request and based on a computing resource allotment for the geographic region, available computing resources for the geographic region, determining, by the data management system, based on the available computing resources, whether to configure at least a portion of the available computing resources for instantiation of an instance of the software-as-a-service product, and providing, by the data management system via the user interface, an indication of whether the instance of the software-as-a-service product is instantiated.

An apparatus is described. The apparatus may include a processor, memory coupled with the processor, and instructions stored in the memory. The instructions may be executable by the processor to cause the apparatus to generate, by a data management system that supports one or more software-as-a-service products, a database for managing one or more subscriptions to a cloud service that provides the data management system access to computing resources managed by the cloud service, generate, by the data management system, based on generating the database, a set of multiple tables for the database, the set of multiple tables corresponding to a set of multiple geographic regions in a geographic area, update, by the data management system, the set of multiple tables based on the one or more subscriptions, where the set of multiple tables is updated to reflect respective computing resource allotments for respective geographic regions as allocated to the data management system by the one or more subscriptions, receive, by the data management system and via a user interface, a request to apply a software-as-a-service product of the one or more software-as-a-service products to data of a customer, where the request originates from a geographic region, identify, by the data management system, in response to the request and based on a computing resource allotment for the geographic region, available computing resources for the geographic region, determine, by the data management system, based on the available computing resources, whether to configure at least a portion of the available computing resources for instantiation of an instance of the software-as-a-service product, and providing, by the data management system via the user interface, an indication of whether the instance of the software-as-a-service product be instantiated.

Another apparatus is described. The apparatus may include means for generating, by a data management system that supports one or more software-as-a-service products, a database for managing one or more subscriptions to a cloud service that provides the data management system access to computing resources managed by the cloud service, means for generating, by the data management system, based on generating the database, a set of multiple tables for the database, the set of multiple tables corresponding to a set of multiple geographic regions in a geographic area, means for updating, by the data management system, the set of multiple tables based on the one or more subscriptions, where the set of multiple tables is updated to reflect respective computing resource allotments for respective geographic regions as allocated to the data management system by the one or more subscriptions, means for receiving, by the data management system and via a user interface, a request to apply a software-as-a-service product of the one or more software-as-a-service products to data of a customer, where the request originates from a geographic region, means for identifying, by the data management system, in response to the request and based on a computing resource allotment for the geographic region, available computing resources for the geographic region, means for determining, by the data management system, based on the available computing resources, whether to configure at least a portion of the available computing resources for instantiation of an instance of the software-as-a-service product, and means for providing, by the data management system via the user interface, an indication of whether the instance of the software-as-a-service product is instantiated.

A non-transitory computer-readable medium storing code is described. The code may include instructions executable by a processor to generate, by a data management system that supports one or more software-as-a-service products, a database for managing one or more subscriptions to a cloud service that provides the data management system access to computing resources managed by the cloud service, generate, by the data management system, based on generating the database, a set of multiple tables for the database, the set of multiple tables corresponding to a set of multiple geographic regions in a geographic area, update, by the data management system, the set of multiple tables based on the one or more subscriptions, where the set of multiple tables is updated to reflect respective computing resource allotments for respective geographic regions as allocated to the data management system by the one or more subscriptions, receive, by the data management system and via a user interface, a request to apply a software-as-a-service product of the one or more software-as-a-service products to data of a customer, where the request originates from a geographic region, identify, by the data management system, in response to the request and based on a computing resource allotment for the geographic region, available computing resources for the geographic region, determine, by the data management system, based on the available computing resources, whether to configure at least a portion of the available computing resources for instantiation of an instance of the software-as-a-service product, and providing, by the data management system via the user interface, an indication of whether the instance of the software-as-a-service product be instantiated.

Some examples of the method, apparatuses, and non-transitory computer-readable medium described herein may further include operations, features, means, or instructions for requesting, from the cloud service, an indication of the respective computing resource allotments for the respective geographic regions and receiving, in response to the requesting, the indication of the respective computing resource allotments for the respective geographic regions, where the set of multiple tables may be updated based on the indication of the respective computing resource allotments for the respective geographic regions.

Some examples of the method, apparatuses, and non-transitory computer-readable medium described herein may further include operations, features, means, or instructions for determining, based on the indication of the respective computing resource allotments, a quantity of available processing unit resources for the geographic region, and calculating a threshold quantity of clusters that may be available to support operation of the software-as-a-service product within the geographic region, where the calculating is based on dividing the quantity of the available processing unit resources for the geographic region by an average quantity of processing unit resources allocated to a cluster.

Some examples of the method, apparatuses, and non-transitory computer-readable medium described herein may further include operations, features, means, or instructions for requesting, from the cloud service, an indication of a current usage of the respective computing resource allotments for the respective geographic regions and receiving, in response to the requesting, the indication of the current usage of the respective computing resource allotments for the respective geographic regions, where the set of multiple tables may be updated based on the indication of the current usage of the respective computing resource allotments for the respective geographic regions.

Some examples of the method, apparatuses, and non-transitory computer-readable medium described herein may further include operations, features, means, or instructions for requesting, from the cloud service, an indication of the respective computing resource allotments for the respective geographic regions and an indication of a current usage of available processing unit resources for the respective geographic regions, determining, based on the indication of the respective computing resource allotments, a quantity of available processing unit resources for the geographic region, a current usage of the available processing unit resources for the geographic region, and a current usage of clusters for the geographic region, and calculating a threshold quantity of clusters that may be available to support operation of the software-as-a-service product within the geographic region, where the calculating is based on dividing a difference between the quantity of the available processing unit resources and the current usage of the available processing unit resources by an average quantity of processing unit resources allocated to a cluster, and combining a result of the dividing with the current usage of clusters for the geographic region.

In some examples of the method, apparatuses, and non-transitory computer-readable medium described herein, operations, features, means, or instructions for identifying the available computing resources for the geographic region may include operations, features, means, or instructions for determining the computing resource allotment for the geographic region and a current usage of the computing resource allotment based on reading a table of the set of multiple tables that may be associated with the geographic region and determining a difference between the computing resource allotment and the current usage of the computing resource allotment, where the available computing resources corresponds to the difference.

Some examples of the method, apparatuses, and non-transitory computer-readable medium described herein may further include operations, features, means, or instructions for determining, based on identifying the available computing resources for the geographic region, that the available computing resources for the geographic region includes computing capacity that exceeds a threshold, where determining whether to configure at least the portion of the available computing resources includes determining to configure at least the portion of the available computing resources based on the computing capacity of the available computing resources exceeding the threshold.

Some examples of the method, apparatuses, and non-transitory computer-readable medium described herein may further include operations, features, means, or instructions for monitoring, using the set of multiple tables, respective computing capacities of available computing resources within the respective geographic regions and issuing, based on monitoring the respective computing capacities, an alert that a computing capacity of available computing resources for a second geographic region may be below a threshold.

Some examples of the method, apparatuses, and non-transitory computer-readable medium described herein may further include operations, features, means, or instructions for requesting, from the cloud service, based on the computing capacity of the available computing resources for the second geographic region being below the threshold, additional computing resources for the second geographic region.

In some examples of the method, apparatuses, and non-transitory computer-readable medium described herein, a first table of the set of multiple tables includes a first unique identifier of the first table, a first identifier of a first subscription associated with the first table, a first identifier of a first geographic region associated with the first table, a first indication of a first computing resource allotment for the first geographic region under the first subscription, a first indication of a current usage of the first computing resource allotment for the first geographic region under the first subscription, a first indication of a first software-as-a-service product of the one or more software-as-a-service products that may be associated with the first subscription, or any combination thereof.

In some examples of the method, apparatuses, and non-transitory computer-readable medium described herein, a table of the set of multiple tables corresponds to a unique combination of the one or more subscriptions and the set of multiple geographic regions.

In some examples of the method, apparatuses, and non-transitory computer-readable medium described herein, the computing resources managed by the cloud service may be configurable to support a remote operation of one or more instances of the one or more software-as-a-service products.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
generating, by a data management system that supports one or more software-as-a-service products, a database for managing one or more subscriptions to a cloud service that provides the data management system access to computing resources managed by the cloud service;
generating, by the data management system, based at least in part on generating the database, a plurality of tables for the database, the plurality of tables corresponding to a plurality of geographic regions in a geographic area;
updating, by the data management system, the plurality of tables based at least in part on the one or more subscriptions, wherein the plurality of tables is updated to reflect respective computing resource allotments for respective geographic regions as allocated to the data management system by the one or more subscriptions;
receiving, by the data management system and via a user interface, a request to apply a software-as-a-service product of the one or more software-as-a-service products to data of a customer, wherein the request originates from a geographic region;
identifying, by the data management system, in response to the request and based at least in part on a computing resource allotment for the geographic region, available computing resources for the geographic region;
determining, by the data management system, based at least in part on the available computing resources, whether to configure at least a portion of the available computing resources for instantiation of an instance of the software-as-a-service product; and
providing, by the data management system via the user interface, an indication of whether the instance of the software-as-a-service product is instantiated.

2. The method of claim 1, further comprising:
requesting, from the cloud service, an indication of the respective computing resource allotments for the respective geographic regions; and
receiving, in response to the requesting, the indication of the respective computing resource allotments for the respective geographic regions, wherein the plurality of tables is updated based at least in part on the indication of the respective computing resource allotments for the respective geographic regions.

3. The method of claim 2, further comprising:
determining, based at least in part on the indication of the respective computing resource allotments, a quantity of available processing unit resources for the geographic region; and
calculating a threshold quantity of clusters that is available to support operation of the software-as-a-service product within the geographic region based at least in part on:
dividing the quantity of the available processing unit resources for the geographic region by an average quantity of processing unit resources allocated to a cluster.

4. The method of claim 1, further comprising:
requesting, from the cloud service, an indication of a current usage of the respective computing resource allotments for the respective geographic regions; and
receiving, in response to the requesting, the indication of the current usage of the respective computing resource allotments for the respective geographic regions, wherein the plurality of tables is updated based at least in part on the indication of the current usage of the respective computing resource allotments for the respective geographic regions.

5. The method of claim 1, further comprising:
requesting, from the cloud service, an indication of the respective computing resource allotments for the respective geographic regions and an indication of a current usage of available processing unit resources for the respective geographic regions;
determining, based at least in part on the indication of the respective computing resource allotments, a quantity of available processing unit resources for the geographic region, a current usage of the available processing unit resources for the geographic region, and a current usage of clusters for the geographic region; and
calculating a threshold quantity of clusters that is available to support operation of the software-as-a-service product within the geographic region based at least in part on:
dividing a difference between the quantity of the available processing unit resources and the current usage of the available processing unit resources by an average quantity of processing unit resources allocated to a cluster, and
combining a result of the dividing with the current usage of clusters for the geographic region.

6. The method of claim 1, wherein identifying the available computing resources for the geographic region comprises:
determining the computing resource allotment for the geographic region and a current usage of the computing resource allotment based at least in part on reading a table of the plurality of tables that is associated with the geographic region; and
determining a difference between the computing resource allotment and the current usage of the computing resource allotment, wherein the available computing resources corresponds to the difference.

7. The method of claim 1, further comprising:
determining, based at least in part on identifying the available computing resources for the geographic region, that the available computing resources for the geographic region comprises computing capacity that exceeds a threshold, wherein determining whether to configure at least the portion of the available computing resources comprises:
determining to configure at least the portion of the available computing resources based at least in part on the computing capacity of the available computing resources exceeding the threshold.

8. The method of claim 1, further comprising:
monitoring, using the plurality of tables, respective computing capacities of available computing resources within the respective geographic regions; and
issuing, based at least in part on monitoring the respective computing capacities, an alert that a computing capacity of available computing resources for a second geographic region is below a threshold.

9. The method of claim 8, further comprising:
requesting, from the cloud service, based at least in part on the computing capacity of the available computing resources for the second geographic region being below the threshold, additional computing resources for the second geographic region.

10. The method of claim 1, wherein a first table of the plurality of tables comprises:
a first unique identifier of the first table,
a first identifier of a first subscription associated with the first table,
a first identifier of a first geographic region associated with the first table,
a first indication of a first computing resource allotment for the first geographic region under the first subscription,
a first indication of a current usage of the first computing resource allotment for the first geographic region under the first subscription,
a first indication of a first software-as-a-service product of the one or more software-as-a-service products that is associated with the first subscription, or
any combination thereof.

11. The method of claim 1, wherein a table of the plurality of tables corresponds to a unique combination of the one or more subscriptions and the plurality of geographic regions.

12. The method of claim 1, wherein the computing resources managed by the cloud service are configurable to support a remote operation of one or more instances of the one or more software-as-a-service products.

13. An apparatus, comprising:
a processor;
memory coupled with the processor; and
instructions stored in the memory and executable by the processor to cause the apparatus to:
generate, by a data management system that supports one or more software-as-a-service products, a database for managing one or more subscriptions to a cloud service that provides the data management system access to computing resources managed by the cloud service;
generate, by the data management system, based at least in part on generating the database, a plurality of tables for the database, the plurality of tables corresponding to a plurality of geographic regions in a geographic area;
update, by the data management system, the plurality of tables based at least in part on the one or more subscriptions, wherein the plurality of tables is updated to reflect respective computing resource allotments for respective geographic regions as allocated to the data management system by the one or more subscriptions;
receive, by the data management system and via a user interface, a request to apply a software-as-a-service product of the one or more software-as-a-service products to data of a customer, wherein the request originates from a geographic region;
identify, by the data management system, in response to the request and based at least in part on a computing resource allotment for the geographic region, available computing resources for the geographic region;
determine, by the data management system, based at least in part on the available computing resources, whether to configure at least a portion of the available computing resources for instantiation of an instance of the software-as-a-service product; and
provide, by the data management system via the user interface, an indication of whether the instance of the software-as-a-service product is instantiated.

14. The apparatus of claim 13, wherein the instructions are further executable by the processor to cause the apparatus to:
request, from the cloud service, an indication of the respective computing resource allotments for the respective geographic regions; and
receive, in response to the requesting, the indication of the respective computing resource allotments for the respective geographic regions, wherein the instructions are further executable by the processor to cause the apparatus to update the plurality of tables based at least in part on the indication of the respective computing resource allotments for the respective geographic regions.

15. The apparatus of claim 13, wherein the instructions are further executable by the processor to cause the apparatus to:
request, from the cloud service, an indication of a current usage of the respective computing resource allotments for the respective geographic regions; and
receive, in response to the requesting, the indication of the current usage of the respective computing resource allotments for the respective geographic regions, wherein the instructions are further executable by the processor to cause the apparatus to update the plurality of tables based at least in part on the indication of the current usage of the respective computing resource allotments for the respective geographic regions.

16. The apparatus of claim 13, wherein the instructions are further executable by the processor to cause the apparatus to:
request, from the cloud service, an indication of the respective computing resource allotments for the respective geographic regions and an indication of a current usage of available processing unit resources for the respective geographic regions;
determine, based at least in part on the indication of the respective computing resource allotments, a quantity of available processing unit resources for the geographic region, a current usage of the available processing unit resources for the geographic region, and a current usage of clusters for the geographic region; and
calculate a threshold quantity of clusters that is available to support operation of the software-as-a-service product within the geographic region, wherein, to calculate the threshold quantity of clusters, the instructions are executable by the processor to cause the apparatus to:
divide a difference between the quantity of the available processing unit resources and the current usage of the available processing unit resources by an average quantity of processing unit resources allocated to a cluster, and
combine a result of the dividing with the current usage of clusters for the geographic region.

17. The apparatus of claim 13, wherein, to identify the available computing resources for the geographic region, the instructions are executable by the processor to cause the apparatus to:
determine the computing resource allotment for the geographic region and a current usage of the computing resource allotment based at least in part on reading a table of the plurality of tables that is associated with the geographic region; and
determine a difference between the computing resource allotment and the current usage of the computing resource allotment, wherein the available computing resources corresponds to the difference.

18. A non-transitory computer-readable medium storing code, the code comprising instructions executable by a processor to:
generate, by a data management system that supports one or more software-as-a-service products, a database for managing one or more subscriptions to a cloud service that provides the data management system access to computing resources managed by the cloud service;
generate, by the data management system, based at least in part on generating the database, a plurality of tables for the database, the plurality of tables corresponding to a plurality of geographic regions in a geographic area;
update, by the data management system, the plurality of tables based at least in part on the one or more subscriptions, wherein the plurality of tables is updated to reflect respective computing resource allotments for respective geographic regions as allocated to the data management system by the one or more subscriptions;
receive, by the data management system and via a user interface, a request to apply a software-as-a-service product of the one or more software-as-a-service products to data of a customer, wherein the request originates from a geographic region;
identify, by the data management system, in response to the request and based at least in part on a computing resource allotment for the geographic region, available computing resources for the geographic region;
determine, by the data management system, based at least in part on the available computing resources, whether to configure at least a portion of the available computing resources for instantiation of an instance of the software-as-a-service product; and
provide, by the data management system via the user interface, an indication of whether the instance of the software-as-a-service product is instantiated.

19. The non-transitory computer-readable medium of claim 18, wherein the instructions are further executable by the processor to:
request, from the cloud service, an indication of the respective computing resource allotments for the respective geographic regions; and
receive, in response to the requesting, the indication of the respective computing resource allotments for the respective geographic regions, wherein the instructions are executable by the processor to update the plurality of tables based at least in part on the indication of the respective computing resource allotments for the respective geographic regions.

20. The non-transitory computer-readable medium of claim 18, wherein the instructions are further executable by the processor to:
request, from the cloud service, an indication of a current usage of the respective computing resource allotments for the respective geographic regions; and
receive, in response to the requesting, the indication of the current usage of the respective computing resource allotments for the respective geographic regions, wherein the instructions are executable by the processor to update the plurality of tables based at least in part on the indication of the current usage of the respective computing resource allotments for the respective geographic regions.
